(19) United States
(12) Patent Application Publication
(10) Pub. No.: US 2019/0302262 A1
(43) Pub. Date: Oct. 3, 2019

(54) LIGHT CONVEYANCE IN A LIDAR SYSTEM WITH A MONOCENTRIC LENS

(71) Applicant: GM Global Technology Operations LLC, Detroit, MI (US)

(72) Inventor: Scott Singer, San Gabriel, CA (US)

(21) Appl. No.: 15/944,190

(22) Filed: Apr. 3, 2018

(51) Int. Cl. G01S 17/32; G01S 7/491; G01S 7/481

(52) U.S. Cl. CPC G01S 17/325; G01S 7/4818; G01S 7/4912

(57) ABSTRACT

A coherent lidar system includes a light source to output a continuous wave, and a modulator to modulate a frequency of the continuous wave and provide a frequency modulated continuous wave (FMCW) signal. The system also includes a ball lens to obtain a receive beam resulting from a reflection of an output signal, obtained from the FMCW signal, by a target, and a light conveyer to convey the receive beam obtained by the ball lens to a beam steering device that directs the receive beam to a receive path of the system.

### INTRODUCTION

The subject disclosure relates to light conveyance in a lidar system with a monocentric lens.

Vehicles (e.g., automobiles, trucks, construction equipment, farm equipment, automated factory equipment) increasingly include sensors that obtain information about the vehicle operation and the environment around the vehicle. Some sensors, such as cameras, radio detection and ranging (radar) systems, and lidar systems can detect and track objects in the vicinity of the vehicle. By determining the relative location and heading of objects around the vehicle, vehicle operation may be augmented or automated to improve safety and performance. For example, sensor information may be used to issue alerts to a driver of the vehicle or to operate vehicle systems (e.g., collision avoidance systems, adaptive cruise control system, autonomous driving system). A coherent lidar system transmits frequency modulated continuous wave (FMCW) light and processes reflected beams to determine information about the target. Information obtained by the lidar system improves as the amount of light reflected by a target that is captured by the lidar system increases. A monocentric lens such as a ball lens, with spherical symmetry, may be used such that the aperture is the diameter of the lens and light enters without angle-dependent distortion. The light obtained by the monocentric lens must be conveyed to the receive path of the lidar system and the light output by the lidar system must be conveyed to the monocentric lens. Accordingly, it is desirable to provide light conveyance in a lidar system with a monocentric lens.

### SUMMARY

In one exemplary embodiment, a coherent lidar system includes a light source to output a continuous wave, and a modulator to modulate a frequency of the continuous wave and provide a frequency modulated continuous wave (FMCW) signal. The system also includes a ball lens to obtain a receive beam resulting from a reflection of an output signal, obtained from the FMCW signal, by a target, and a light conveyer to convey the receive beam obtained by the ball lens to a beam steering device that directs the receive beam to a receive path of the system.

In addition to one or more of the features described herein, the light conveyer includes a bundle of optical fibers in a fiber taper bundle.

In addition to one or more of the features described herein, the light conveyer further includes a collimator such that the ball lens is at one end of the fiber taper bundle and the collimator is at an opposite end of the fiber taper bundle.

In addition to one or more of the features described herein, the collimator is configured to direct the receive beam conveyed from the ball lens through the fiber taper bundle to the beam steering device.

In addition to one or more of the features described herein, the light conveyer includes an array of lenses arranged adjacent to the ball lens as a micro lens array.

In addition to one or more of the features described herein, the light conveyer further includes a static mirror configured to reflect the receive beam that is obtained by the ball lens and focused on the static mirror by the micro lens array onto the beam steering device.

In addition to one or more of the features described herein, the system also includes a circulator, wherein the system is monostatic and uses the same ball lens to transmit the output signal and obtain the receive beam.

In addition to one or more of the features described herein, the system also includes a second ball lens and a second beam steering device to transmit the output signal, wherein the system is bistatic.

In another exemplary embodiment, a method of assembling a coherent lidar system includes arranging a light source to output a continuous wave, and disposing elements to modulate the continuous wave and provide a frequency modulated continuous wave (FMCW) signal. The method also includes disposing a balls lens to obtain a receive beam resulting from reflection of an output signal, obtained from the FMCW signal, by a target, and arranging a light conveyer to convey the receive beam obtained by the ball lens to a beam steering device that directs the receive beam to a receive path of the lidar system.

In addition to one or more of the features described herein, the arranging the light conveyer includes arranging a bundle of optical fibers as a fiber taper bundle configured to receive the receive beam obtained by the ball lens.

In addition to one or more of the features described herein, the arranging the light conveyer further includes arranging a collimator such that the ball lens is at one end of the fiber taper bundle and the collimator is at an opposite end of the fiber taper bundle.

In addition to one or more of the features described herein, the arranging the collimator includes configuring the collimator to direct the receive beam conveyed from the ball lens through the fiber taper bundle to the beam steering device.

In addition to one or more of the features described herein, the arranging the light conveyer includes arranging an array of lenses adjacent to the ball lens as a micro lens array.

In addition to one or more of the features described herein, the arranging the light conveyer further includes arranging a static mirror to reflect the receive beam that is obtained by the ball lens and focused on the static mirror by the micro lens array onto the beam steering device.

In another exemplary embodiment, a vehicle includes a coherent lidar system that includes a light source to output a continuous wave, and a modulator to modulate a frequency of the continuous wave and provide a frequency modulated continuous wave (FMCW) signal. The coherent lidar system also includes a ball lens to obtain a receive beam resulting from a reflection of an output signal, obtained from the FMCW signal, by a target, and a light conveyer to convey the receive beam obtained by the ball lens to a beam steering device that directs the receive beam to a receive path of the system. The vehicle also includes a vehicle controller to control the vehicle based on information obtained from the receive beam in the coherent lidar system.

In addition to one or more of the features described herein, the light conveyer includes a bundle of optical fibers in a fiber taper bundle.

In addition to one or more of the features described herein, the light conveyer further includes a collimator such that the ball lens is at one end of the fiber taper bundle and the collimator is at an opposite end of the fiber taper bundle, and the collimator directs the receive beam conveyed from the ball lens through the fiber taper bundle to the beam steering device.

In addition to one or more of the features described herein, the light conveyer includes an array of lenses arranged adjacent to the ball lens as a micro lens array.

In addition to one or more of the features described herein, the light conveyer further includes a static mirror configured to reflect the receive beam that is obtained by the ball lens and focused on the static mirror by the micro lens array onto the beam steering device.

In addition to one or more of the features described herein, the coherent lidar system further comprises a circulator, wherein the system is monostatic and uses the same ball lens to transmit the output signal and obtain the receive beam, or further comprises a second ball lens and a second beam steering device to transmit the output signal, wherein the system is bistatic.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a scenario involving a coherent lidar system according to one or more embodiments;

FIG. 2 is a block diagram of a coherent lidar system with a light conveyer according to one or more embodiments;

FIG. 3 is a block diagram of a coherent lidar system with light conveyers according to alternate one or more embodiments;

FIG. 4. illustrates a light conveyer according to an exemplary embodiment;

FIG. 5 is a cross-sectional view of a fiber taper bundle used as a light conveyer according to an exemplary embodiment;

FIG. 6 illustrates a light conveyer according to an exemplary embodiment; and

FIG. 7 is a process flow of a method of assembling a coherent lidar system with a light conveyer according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, sensors may be used to augment or automate vehicle operation. As also noted, one type of sensor is a coherent lidar system that transmits an FMCW signal. The system takes advantage of phase coherence between the transmitted FMCW signal and a reflected signal resulting from reflection of the transmitted FMCW signal by a target. The interference between the reflected signal and a copy of the transmitted signal is used to determine information such as target distance and speed. The coherent lidar system differs from prior time-of-flight lidar systems that transmit a series of pulses and use the duration for transmission of each pulse and reception of the resulting reflection to determine a set of distances for the target.

When the output signal encounters a target within the field of view of the lidar system, the resulting reflected light is scattered in all directions. As previously noted, information obtained by a lidar system improves with an increase in the amount of that reflected light that the lidar system is able to obtain. A ball lens may be used to obtain reflected light from a number of different angles, for example. The reflected light obtained by the ball lens must be conveyed to a beam steering device that provides the reflected light for processing. Embodiments of the systems and methods detailed herein relate to light conveyance in a coherent lidar system with a monocentric lens. A fiber taper bundle may be used in accordance with one exemplary embodiment. A micro lens array and a static mirror or mirror array may be used according to another exemplary embodiment.

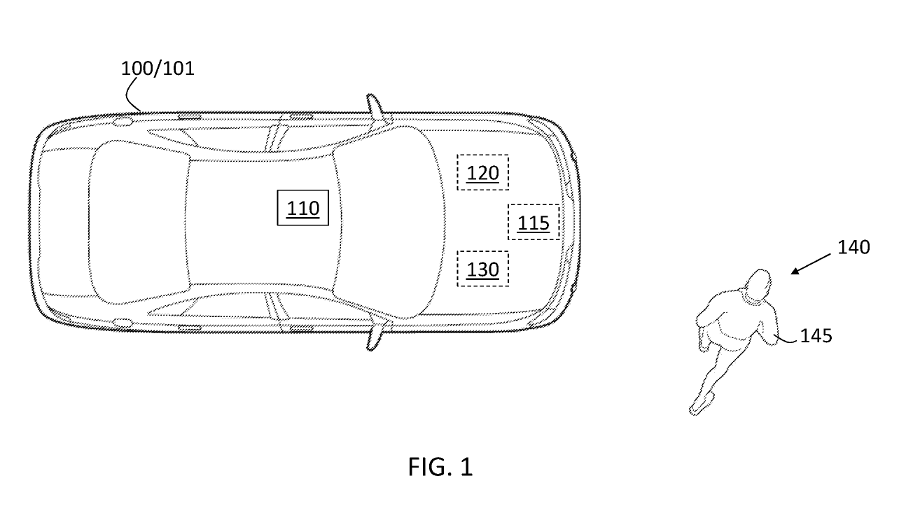

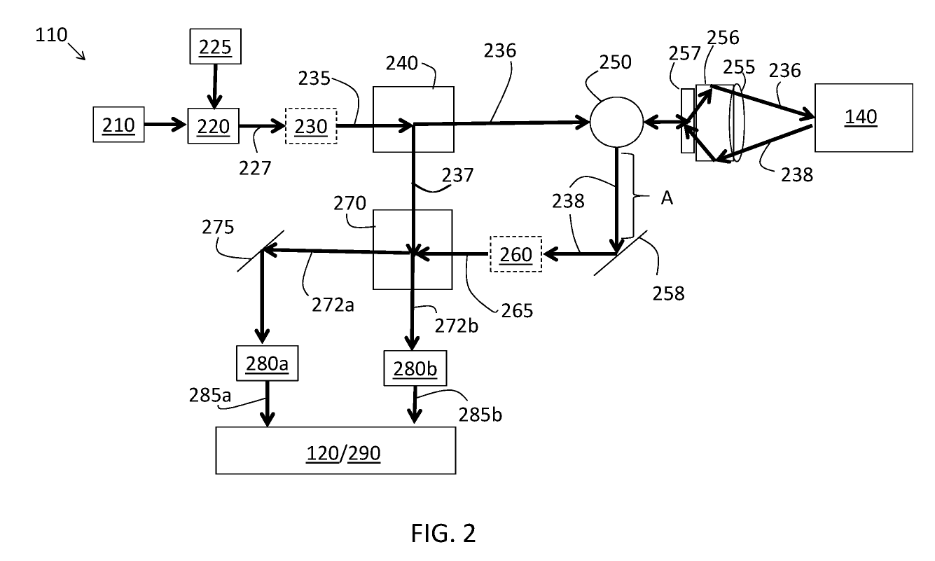

In accordance with an exemplary embodiment, FIG. 1 is a block diagram of a scenario involving a coherent lidar system 110. The vehicle 100 shown in FIG. 1 is an automobile 101. A coherent lidar system 110, further detailed with reference to FIG. 2, is shown on the roof of the automobile 101. According to alternate or additional embodiments, one or more lidar systems 110 may be located elsewhere on the vehicle 100. Another sensor 115 (e.g., camera, microphone, radar system) is shown, as well. Information obtained by the lidar system 110 and one or more other sensors 115 may be provided to a controller 120 (e.g., electronic control unit (ECU)).

The controller 120 may use the information to control one or more vehicle systems 130. In an exemplary embodiment, the vehicle 100 may be an autonomous vehicle and the controller 120 may perform known vehicle operational control using information from the lidar system 110 and other sources. In alternate embodiments, the controller 120 may augment vehicle operation using information from the lidar system 110 and other sources as part of a known system (e.g., collision avoidance system, adaptive cruise control system). The lidar system 110 and one or more other sensors 115 may be used to detect objects 140, such as the pedestrian 145 shown in FIG. 1. The controller 120 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

FIG. 2 is a block diagram of a coherent lidar system 110 with a light conveyer 256 according to one or more embodiments. The exemplary lidar system 110 shown in FIG. 2 is a monostatic system that uses the same aperture lens (i.e., ball lens 255) for light output from the lidar system 110 as an output signal 236 and light obtained by the lidar system 110 as a receive beam 238. The lidar system 110 includes a light source 210. The light source 210 may be a laser diode such as a distributed feedback (DFB) laser according to an exemplary embodiment. The light source 210 outputs a continuous wave of light, which exhibits a constant amplitude. The next stage in the light output system includes an optical resonator 220.

The resonator 220 is an external optical cavity, external to the light source 210. According to the exemplary embodiment shown in FIG. 2, a controlled voltage 225 from a voltage source is applied to the resonator 220 to perform electro-optical modulation and modulate the frequency of the continuous wave of light in the resonator 220 to produce FMCW light 227. According to the exemplary embodiment, the feedback of some light from the resonator 220 to the light source 210 means that the light generated within the light source 210 and the light output by the resonator 220 are modulated synchronously. The controlled voltage 225 may be increased or decreased linearly in order to produce light that exhibits linear frequency modulation (i.e., a linear FMCW signal). Alternately, the controlled voltage 225 may be varied non-linearly to produce light that exhibits non-linear frequency modulation.

According to alternate embodiments, the FMCW light 227 may be obtained by modulating the frequency at the light source 210 itself. In this case, the controlled voltage 225 applied to the resonator 220, as shown in FIG. 2, may be applied directly to block 210. For example, the bias current of the laser chip may be changed or a physical cavity or mirror of the light source 210 may be modulated. This modulation may be implemented by piezoelectric or microelectromechanical systems (MEMS) actuation, for example. As FIG. 2 indicates, an optional optical amplifier 230 may be used to amplify the FMCW light 227 output by the resonator 220 to produce the FMCW signal 235.

A beam splitter 240 is used to split the FMCW signal 235 into an output signal 236 and a local oscillator (LO) signal 237. Both the output signal 236 and the LO signal 237 exhibit the frequency modulation imparted by the controlled voltage 225 or other modulator. The beam splitter 240 may be an on-chip waveguide splitter, for example. The output signal 236 is provided to a light circulating element such as a circulator 250, which is necessary in the monostatic system shown in FIG. 2 to facilitate using the same ball lens 255 for both the transmit and receive paths. The circulator 250 directs the output signal 236 out of the lidar system 110 through an aperture.

The aperture lens is a monocentric lens such as a ball lens 255, according to the exemplary embodiment shown in FIG. 2. As previously noted, the ball lens 255 facilitates obtaining more of the light reflected by a target 140 into the lidar system 110 because the aperture is simply the diameter of the ball lens 255. The incoming light enters without angle-dependent distortion. This facilitates a wider field of view with the maximum detectable range being angle-independent. A beam steering device 257 ensures proper alignment of the output signal 236 exiting the lidar system 110 and proper alignment of the receive beam 238 that enters the lidar system 110 and must be properly aligned for ultimate interference at the photodiodes 280. The beam steering device 257 may be a reflector. According to the exemplary embodiment shown in FIG. 2, the beam steering device 257 is a MEMS scanning mirror.

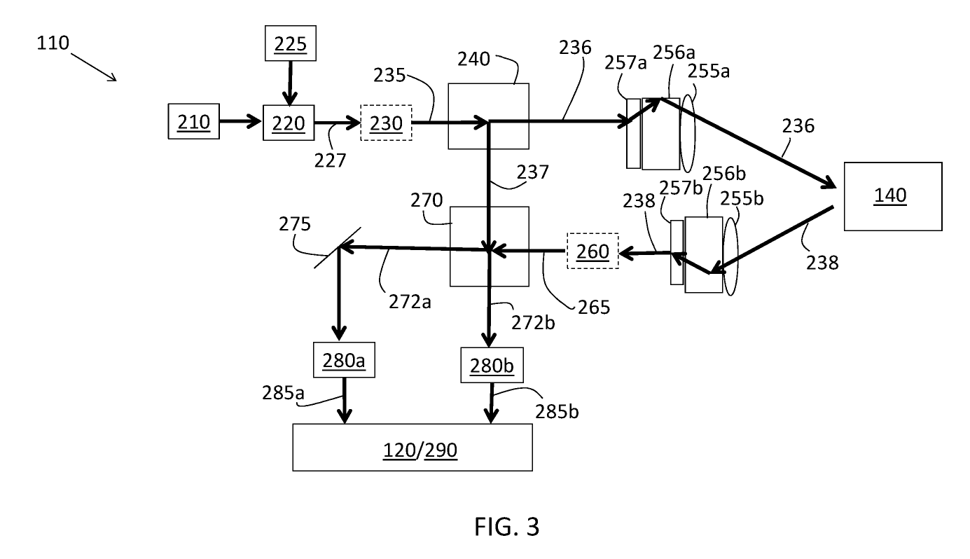

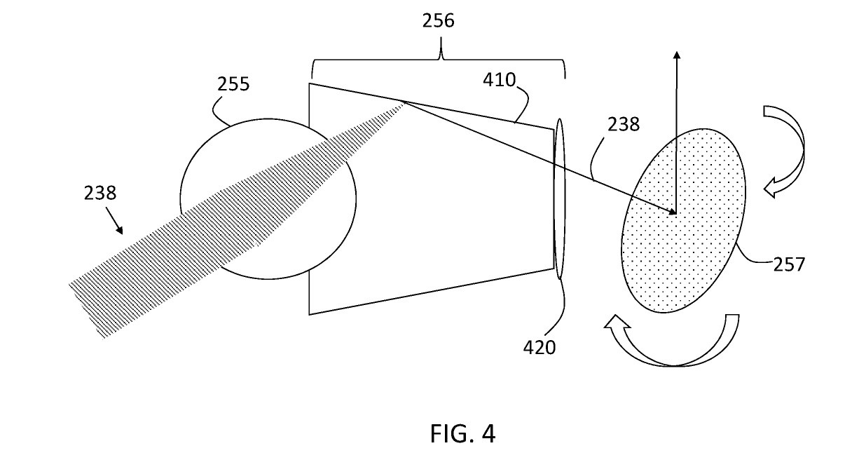

A light conveyer 256 conveys light between the beam steering device 257 and the ball lens 255. Different embodiments of the light conveyer 256 are detailed with reference to FIGS. 3 and 4. If a target 140 is in the field of view of the lidar system 110, as in the example shown in FIG. 2, the FMCW output signal 236 output from the lidar system 110 is scattered by the target 140. Some of that scattered light reenters the lidar system 110 as a receive beam 238. The receive beam 238 enters the ball lens 255, is conveyed by the light conveyer 256 to the beam steering device 257, and is directed by the circulator 250 to a reflector 258. The reflector 258 directs the receive beam 238 to an optional optical amplifier 260 according to one or more embodiments.

While the optical amplifier 260 is shown between the reflector 258 and an alignment element 270 in FIG. 2, the optical amplifier 260 may instead be located between the circulator 250 and the reflector 258, along the path indicated as A. According to exemplary embodiments, the optical amplifier 260 may include coupling lenses to direct the receive beam 238 into the optical amplifier 260 without loss. The optical amplifier 260 may also include shaping optics to ensure that the amplified receive beam 265 output by the optical amplifier 260 has the correct profile.

The amplified receive beam 265 is provided to the alignment element 270 in which with the amplified receive beam 265 is aligned with the LO signal 237. The alignment element 270 ensures that the amplified receive beam 265 and the LO signal 237 are co-linear and splits the output into two co-linear signals 272a, 272b (generally referred to as 272). The co-linear signals 272a, 272b are respectively directed to a photodetectors 280a, 280b (generally referred to as 280). As FIG. 2 indicates, one of the coherent signals 272a is reflected by a reflector 275 in order to be directed into the corresponding photodetector 280a. The amplified receive beam 265 and LO signal 237, which are aligned in the co-linear signals 272, interfere with each other in the photodetectors 280. The interference between the amplified receive beam 265 and the LO signal 237 results in a coherent combination of the two beams. Thus, the lidar system 110 is referred to as a coherent lidar system, unlike the time-of-flight systems. The interference in each photodetector 280 represents an autocorrelation function to identify an amplified receive beam 265 that resulted from the output signal 236. This prevents errant light from another light source outside the lidar system 110 that is within the field of view of the lidar system 110 from being mistaken for a receive beam 238 that is reflected by a target 140.

The photodetectors 280 are semiconductor devices that convert the result of the interference between the amplified receive beam 265 and the LO signal 237 in each co-linear signal 272 into electrical currents 285a, 285b (generally referred to as 285). Two photodetectors 280 are used in accordance with a known balanced detector technique to cancel noise that is common to both photodetectors 280. The electrical currents 285 from each of the photodetectors 280 are combined and processed to obtain information like range to the target 140, speed of the target 140, and other information according to known processing techniques. The processing may be performed within the lidar system 110 by a processor 290 or outside the lidar system 110 by the controller 120, for example. The processor 290 may include processing circuitry similar to that discussed for the controller 120.

The power of each co-linear signal 272, which is converted to an alternating photocurrent (i.e., electrical current 285) by each photodetector 280, may be approximated (up to a constant) as:

$$\begin{matrix}d \\ R\end{matrix} \sqrt{ρ {P}_{LO} {P}_{TX}} \qquad [ EQ . 1 ]$$

In EQ. 1, d is the aperture diameter (e.g., diameter of the ball lens 255), R is the range to the target 140, ρ is the target scattering efficiency or reflectivity, P_{LO} is the power of the local oscillator, and P_{TX} is the total power of the output signal 236 transmitted to the target 140. Thus, by increasing the aperture diameter d, the collected signal (receive beam 238) increases proportionally or linearly. The maximum range detectable by the lidar system 110 for fixed powers of the LO signal 237 and output signal 236 increases accordingly, as well. The diameter of the ball lens 255 may be on the order of a half inch to an inch, for example. In comparison with a lidar whose aperture is limited by a MEMS mirror, which has a diameter on the order of 1-5 millimeters, the use of the ball lens 255 improves the collected receive beam 238 by a factor of 5-25.

FIG. 3 is a block diagram of a coherent lidar system 110 with light conveyers 256a, 256b (generally referred to as 256) according to alternate one or more embodiments. A bistatic lidar system 110 is shown in the exemplary embodiment of FIG. 3. Most of the bistatic lidar system 110, shown in FIG. 3, is identical to the monostatic lidar system 110, shown in FIG. 2. Thus, the components detailed with reference to FIG. 2 are not discussed again. As previously noted, the primary difference between the monostatic and bistatic systems is in the inclusion, in the bistatic system, of separate beam steering devices 257a, 257b (generally referred to as 257), light conveyers 256a, 256b (generally referred to as 256), and ball lenses 255a, 255b (generally referred to as 255) for the output signal 236 and receive beam 238. As such, a circulator 250 is not needed in the bistatic system of FIG. 3.

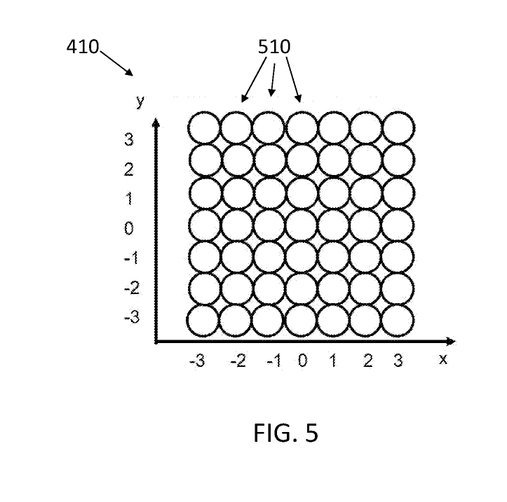

FIG. 4 shows a cross-sectional view of a light conveyer 256 according to an exemplary embodiment. According to the present embodiment, the light conveyer 256 includes a fiber taper bundle 410. The fiber taper bundle 410 is comprised of optical fibers bundled together. The receive beam 238 is focused by the ball lens 255 into a subset of the fiber taper bundle 410. According to an exemplary embodiment, the light conveyer 256 may additionally include a collimator 420, comprised of a lens or micro lens array. The receive beam 238 that was focused into a subset of the fiber taper bundle 410 exits the end of the fiber taper bundle 410 where the collimator 420 is located. The receive beam is provided to the beam steering device 257 which is oriented to direct the receive beam 238 to the receive path of the lidar system 110. As indicated by FIG. 4, the fiber taper bundle 410 may be tapered such that each optical fiber 510 (FIG. 5) has a smaller diameter at the exit end than at the entrance end to facilitate alignment of the receive beam 238 to the beam steering device 257. In the case of the monostatic system, the beam steering device 257 directs the receive beam 238 to the circulator 250. As FIG. 4 illustrates, the use of the light conveyer 256 increases the field of view of the lidar system 110. This is because reflected light entering the ball lens 255 from any angle can be captured and aligned for processing via the fiber taper bundle 410. The end of the fiber taper bundle 410 that is closest to the ball lens 255 may be shaped to fit around the ball lens 255 and provide optimal coupling.

FIG. 5 is a cross-sectional view of a fiber taper bundle 410 used as a light conveyer 256 according to an exemplary embodiment. The cross section shown in FIG. 5 is perpendicular to the cross section shown in FIG. 4. The individual optical fibers 510 of the fiber taper bundle 410 are indicated on an (x, y) scale. The input angle of a receive beam 238 on the spherical ball lens 255 is given by (θ, φ). This angle is mapped to optical fibers 510 of the fiber taper bundle 410 at (x, y). The light conveyed along the optical fibers 510 is then mapped to a tilt angle of the beam steering device 257 given by (α, β). The mappings are based on one-to-one functions f and g:

$$( \begin{matrix}θ \\ ϕ\end{matrix} ) {\to }^{f} ( \begin{matrix}x \\ y\end{matrix} ) {\to }^{g} ( \begin{matrix}α \\ β\end{matrix} ) \qquad [ EQ . 2 ]$$

Since the mapping from the spherical ball lens 255 to the fiber taper bundle 410 is given by f, the mapping from a given optical fiber 510 of the fiber taper bundle 410 to the angle (θ, φ) at which the light entered the spherical ball lens 255 is given by f¹. That is, (θ, φ)=f¹(−1, 1) when the optical fiber 510 at x and y values of −1 and 1, respectively, carries the receive beam 238. The tilt angle (α, β) of the beam steering device 257 may then be obtained using the function g such that (α, β)=g(−1, 1).

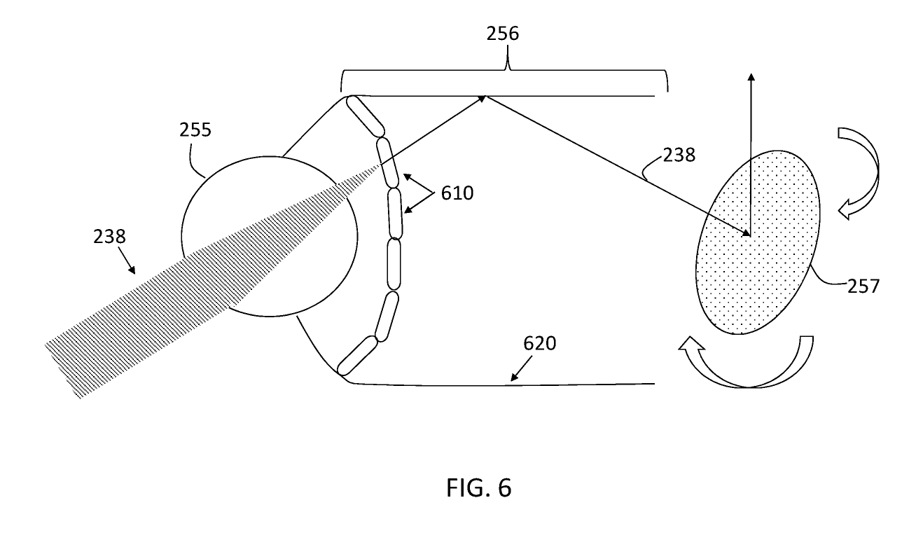

FIG. 6 shows a cross-sectional view of a light conveyer 256 according to another exemplary embodiment. The light conveyer 256 according to the present embodiment includes a micro lens array 610 and a static mirror 620, which may be implemented as a mirror array according to an exemplary embodiment. The static mirror 520 may have a cylindrical geometry, as indicated by the cross-sectional shape shown in FIG. 6, or may have another geometry to reflect the receive beam 238 focused by the micro lens array 610. As FIG. 6 illustrates, the micro lens array 610 focuses the receive beam 238 obtained by the ball lens 255 onto the static mirror 620. The static mirror 620 reflects the receive beam 238 to the beam steering device 257 which is oriented to direct the receive beam 238 to the receive path of the lidar system 110. As previously noted, in the case of a monostatic system, this means directing the receive beam 238 to the circulator 250.

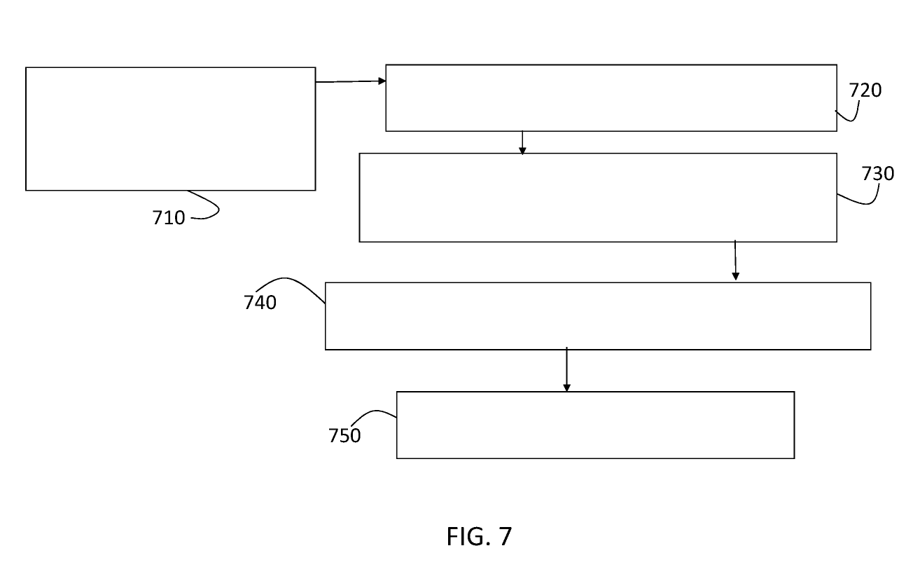

FIG. 7 is a process flow of a method of assembling a coherent lidar system 110 with a light conveyer 236 according to one or more embodiments. At block 710, arranging a light source 210 to output a continuous wave may include using a DFB laser, for example, and arranging elements to provide an FMCW light 227 from the continuous wave may include arranging a resonator 220 and controlled voltage 225 at the output of the light source 210, as shown in FIGS. 2 and 3. The process at block 710 may additionally including arranging an optical amplifier 230 to produce the amplified FMCW signal 235 from the FMCW light 227. At block 720, the processes include arranging a beam splitter 240 to produce an output signal 246 and an LO signal 237 from the FMCW signal 235 (or FMCW light 227).

At block 730, arranging one or two sets of a beam steering device 257, light conveyer 256, and ball lens 255 to transmit the output signal 236 and obtain the receive beam 238 differs based on whether the lidar system 110 is a monostatic system or a bistatic system, as indicated by FIGS. 2 and 3. A monostatic system, as shown in FIG. 2, requires arranging only one set of the elements but additionally requires disposing a circulator 250 to direct the output signal 236 to the beam steering device 257 and to direct the receive beam 238 from the beam steering device 257 to the receive elements.

Disposing the alignment element 270 to make the receive beam 238 and the LO signal 327 co-linear, at block 740, may additionally include disposing an optical amplifier 260 to amplify the receive beam 238 prior to alignment. At block 750, the processes include disposing photodiodes 280 and a processor 120, 290 to detect and process coherent signals. Two photodiodes 280 are arranged in the embodiments shown in FIGS. 2 and 3. In each photodiode 280, interference of the co-linear receive beam 238 (or amplified receive beam 265) and LO signal 237 in the co-linear signal 272 results in a coherent combination. The current output by each of the photodiodes 280 is processed by the processor 120, 290 to obtain information like the position and speed of the target 140.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A coherent lidar system, comprising:
a light source configured to output a continuous wave;
a modulator configured to modulate a frequency of the continuous wave and provide a frequency modulated continuous wave (FMCW) signal;
a ball lens configured to obtain a receive beam resulting from a reflection of an output signal, obtained from the FMCW signal, by a target; and
a light conveyer configured to convey the receive beam obtained by the ball lens to a beam steering device that directs the receive beam to a receive path of the system.

2. The system according to claim 1, wherein the light conveyer includes a bundle of optical fibers in a fiber taper bundle.

3. The system according to claim 2, wherein the light conveyer further includes a collimator such that the ball lens is at one end of the fiber taper bundle and the collimator is at an opposite end of the fiber taper bundle.

4. The system according to claim 3, wherein the collimator is configured to direct the receive beam conveyed from the ball lens through the fiber taper bundle to the beam steering device.

5. The system according to claim 1, wherein the light conveyer includes an array of lenses arranged adjacent to the ball lens as a micro lens array.

6. The system according to claim 5, wherein the light conveyer further includes a static mirror configured to reflect the receive beam that is obtained by the ball lens and focused on the static mirror by the micro lens array onto the beam steering device.

7. The system according to claim 1, further comprising a circulator, wherein the system is monostatic and uses the same ball lens to transmit the output signal and obtain the receive beam.

8. The system according to claim 1, further comprising a second ball lens and a second beam steering device to transmit the output signal, wherein the system is bistatic.

9. A method of assembling a coherent lidar system, the method comprising:
arranging a light source to output a continuous wave;
disposing elements to modulate the continuous wave and provide a frequency modulated continuous wave (FMCW) signal;
disposing a balls lens to obtain a receive beam resulting from reflection of an output signal, obtained from the FMCW signal, by a target; and
arranging a light conveyer to convey the receive beam obtained by the ball lens to a beam steering device that directs the receive beam to a receive path of the lidar system.

10. The method according to claim 9, wherein the arranging the light conveyer includes arranging a bundle of optical fibers as a fiber taper bundle configured to receive the receive beam obtained by the ball lens.

11. The method according to claim 10, wherein the arranging the light conveyer further includes arranging a collimator such that the ball lens is at one end of the fiber taper bundle and the collimator is at an opposite end of the fiber taper bundle.

12. The method according to claim 11, wherein the arranging the collimator includes configuring the collimator to direct the receive beam conveyed from the ball lens through the fiber taper bundle to the beam steering device.

13. The method according to claim 9, wherein the arranging the light conveyer includes arranging an array of lenses adjacent to the ball lens as a micro lens array.

14. The method according to claim 13, wherein the arranging the light conveyer further includes arranging a static mirror to reflect the receive beam that is obtained by the ball lens and focused on the static mirror by the micro lens array onto the beam steering device.

15. A vehicle, comprising:
a coherent lidar system comprising:
a light source configured to output a continuous wave;
a modulator configured to modulate a frequency of the continuous wave and provide a frequency modulated continuous wave (FMCW) signal;
a ball lens configured to obtain a receive beam resulting from a reflection of an output signal, obtained from the FMCW signal, by a target; and
a light conveyer configured to convey the receive beam obtained by the ball lens to a beam steering device that directs the receive beam to a receive path of the system; and
a vehicle controller configured to control the vehicle based on information obtained from the receive beam in the coherent lidar system.

16. The vehicle according to claim 15, wherein the light conveyer includes a bundle of optical fibers in a fiber taper bundle.

17. The vehicle according to claim 16, wherein the light conveyer further includes a collimator such that the ball lens is at one end of the fiber taper bundle and the collimator is at an opposite end of the fiber taper bundle, and the collimator is configured to direct the receive beam conveyed from the ball lens through the fiber taper bundle to the beam steering device.

18. The s vehicle according to claim 15, wherein the light conveyer includes an array of lenses arranged adjacent to the ball lens as a micro lens array.

19. The vehicle according to claim 19, wherein the light conveyer further includes a static mirror configured to reflect the receive beam that is obtained by the ball lens and focused on the static mirror by the micro lens array onto the beam steering device.

20. The vehicle according to claim 15, wherein the coherent lidar system further comprises a circulator, wherein the system is monostatic and uses the same ball lens to transmit the output signal and obtain the receive beam, or further comprises a second ball lens and a second beam steering device to transmit the output signal, wherein the system is bistatic.
